(19) United States
(12) Patent Application Publication
(10) Pub. No.: US 2021/0020341 A1
(43) Pub. Date: Jan. 21, 2021

(54) NANOCRYSTALLINE SOFT MAGNETIC ALLOY MATERIAL AND MAGNETIC COMPONENT

(71) Applicant: Murata Manufacturing Co., Ltd., Kyoto-fu (JP)

(72) Inventor: Kazuhiro HENMI, Nagaokakyo-shi (JP)

(73) Assignee: Murata Manufacturing Co., Ltd., Kyoto-fu (JP)

(21) Appl. No.: 16/930,200

(22) Filed: Jul. 15, 2020

(30) Foreign Application Priority Data
Jul. 18, 2019 (JP) 2019-132566

(51) Int. Cl. H01F 1/153

(52) U.S. Cl. CPC H01F 1/15308; H01F 1/15333; H01F 1/15316

(57) ABSTRACT

A nanocrystalline soft magnetic alloy material contains a nanocrystal and has an alloy composition of Fe_{100-a-b-c-d-e-f}M1ₐP_{b}Cu_{c}Co_{d}NiₑM2_{f}, in which M1 is at least one element selected from the group consisting of Si, B, and C; M2 is at least one element selected from the group consisting of V, Zr, Nb, Mo, Hf, Ta, W, Sn, Bi, and In; and a through f satisfy 3≤a≤20, 1≤b≤10, 0.1≤c≤1.5, 0≤d≤5, 0≤e≤5, and 0≤f≤3, where a through f each correspond to number of parts by mole of each element in the alloy composition. A surface region of the material contains an average of 29 atom % or more of an O element, and extends from a surface of the nanocrystalline soft magnetic alloy material to a depth of 30 nm.

### CROSS-REFERENCE TO RELATED APPLICATION

This application claims benefit of priority to Japanese Patent Application No. 2019-132566, filed Jul. 18, 2019, the entire content of which is incorporated herein by reference.

### BACKGROUND

### Technical Field

The present disclosure relates to a nanocrystalline soft magnetic alloy material and a magnetic component. More specifically, the present disclosure relates to a nanocrystalline soft magnetic alloy material containing a nanocrystal, and a magnetic component containing the nanocrystalline soft magnetic alloy material.

### Background Art

Soft magnetic materials are used in various products including electronic devices. More specifically, soft magnetic materials are used in magnetic components, and are used, for example, in a core material of a coil component in electronic devices.

As soft magnetic materials, soft magnetic alloys having an alloy composition are known. For example, Japanese Patent Application Laid-Open No. 2016-94652 proposes a nanocrystalline soft magnetic alloy material that is obtained by heating an amorphous base precursor to precipitate a crystal.

### SUMMARY OF THE INVENTION

The present inventor has noticed that conventional nanocrystalline soft magnetic alloy materials still have problems to be overcome, and has found that it is necessary to take measures for the problems. Specifically, the present inventor has found that conventional nanocrystalline soft magnetic alloy materials have the following problems.

The nanocrystalline soft magnetic alloy material of Japanese Patent Application Laid-Open No. 2016-94652 has a structure in which α-Fe crystals are precipitated in an amorphous matrix even when the nanocrystalline soft magnetic alloy material does not contain boron (B). Although such an alloy material has a high saturation magnetic flux density owing to a higher concentration of Fe that is responsible for magnetism, the higher Fe concentration requires reduction of the amount of other elements to be added.

For example, if any elements capable of contributing to corrosion resistance are to be added to the soft magnetic alloy material, the amount of the elements will be reduced. In such a case, the alloy material may rust from the surface thereof. In other words, it is concerned that a magnetic component containing such a soft magnetic alloy material may have lower reliability.

Accordingly, the present disclosure provides a nanocrystalline soft magnetic alloy material preferred in terms of both the saturation magnetic flux density and the corrosion resistance.

The present inventor has attempted to solve the above-mentioned problems not as an extension of conventional techniques but by coping with the problems from a new direction. As a result, the present inventor has arrived at an disclosure of a nanocrystalline soft magnetic alloy material capable of achieving the features discussed herein.

The present disclosure provides a nanocrystalline soft magnetic alloy material containing a nanocrystal, the nanocrystalline soft magnetic alloy material having an alloy composition of Fe_{100-a-b-c-d-e-f}M1ₐP_{b}Cu_{c}Co_{d}NiₑM2_{f}, wherein M1 is at least one element selected from the group consisting of Si, B, and C; M2 is at least one element selected from the group consisting of V, Zr, Nb, Mo, Hf, Ta, W, Sn, Bi, and In; and a, b, c, d, e, and f satisfy 3≤a≤20, 1≤b≤10, 0.1≤c≤1.5, 0≤d≤5, 0≤e≤5, and 0≤f≤3, where a, b, c, d, e, and f each correspond to number of parts by mole of each element based on 100 parts by mole in total of the alloy composition. A surface region of the nanocrystalline soft magnetic alloy material contains an average of 29 atom % or more of an O element, and the surface region extends from a surface of the nanocrystalline soft magnetic alloy material to a depth of 30 nm.

The nanocrystalline soft magnetic alloy material of the present disclosure is preferred in terms of both the saturation magnetic flux density and the corrosion resistance.

More specifically, the nanocrystalline soft magnetic alloy material of the present disclosure has a preferred saturation magnetic flux density. In addition, while having a preferred saturation magnetic flux density, the nanocrystalline soft magnetic alloy material of the present disclosure maintains preferred corrosion resistance. In other words, the present disclosure provides a nanocrystalline soft magnetic alloy material in which the saturation magnetic flux density and the corrosion resistance are compatible at a preferred level.

### BRIEF DESCRIPTION OF THE DRAWINGS

FIG. 1A shows Table 1-1 (examples) indicating alloy compositions and content characteristics of nanocrystalline soft magnetic alloy materials in a verification test;

FIG. 1B shows Table 1-2 (comparative examples) indicating alloy compositions and content characteristics of nanocrystalline soft magnetic alloy materials in the verification test;

FIG. 2A shows Table 2-1 (examples) indicating the saturation magnetic flux density and corrosion resistance of the nanocrystalline soft magnetic alloy materials in the verification test; and

FIG. 2B shows Table 2-2 (comparative examples) indicating the saturation magnetic flux density and corrosion resistance of the nanocrystalline soft magnetic alloy materials in the verification test.

### DETAILED DESCRIPTION

Hereinafter, embodiments of the present disclosure will be described. However, the embodiments are for illustration purposes, and the present disclosure is not particularly limited to the embodiments described below.

Various numerical ranges mentioned herein are intended to include the numerical values of the lower and upper limits themselves. Unless otherwise specified, numerical ranges without the term “or more” or “or less”, not to mention numerical ranges with such term, include the numerical values themselves. For example, taking a numerical range “1 to 10” as an example, it is interpreted that the numerical range includes the lower limit “1” and also includes the upper limit “10”.

The soft magnetic alloy material according to one embodiment of the present disclosure contains a nanocrystal. In other words, the soft magnetic alloy material is an alloy material containing a phase of minute-sized crystals. Preferably, the soft magnetic alloy material of the present disclosure contains not only a crystal phase but also an amorphous phase. Due to such a form, the soft magnetic alloy material of the present disclosure is referred to as a nanocrystalline soft magnetic alloy material (hereinafter, the present disclosure will be described also with a simple designation of “soft magnetic alloy material”).

The soft magnetic alloy material according to a preferred embodiment of the present disclosure is an alloy material in which a plurality of crystal grains are dispersed in an amorphous phase. The crystal grains preferably have a nano-sized grain size, and therefore, in the soft magnetic alloy material, nano-order crystal grains may be present in the amorphous phase. By way of example only, the crystal grains preferably have an average grain size of about 70 nm or less. For example, the crystal grains may have an average grain size of about 60 nm or less, about 50 nm or less, or about 40 nm or less. The lower limit of the average grain size is not particularly limited, and may be, for example, about 5 nm, about 10 nm, about 15 nm, or about 20 nm.

The “average grain size” referred to herein broadly means an average grain size obtained from at least an image of crystal grains. In particular, such an average grain size of crystal grains is a value calculated using a transmission electron microscope (TEM), and the Scherrer equation from the X-ray diffractometry.

The crystal grains are preferably Fe nanocrystal grains. The Fe nanocrystal grains may be, for example, α-Fe nanocrystal grains. The soft magnetic alloy material according to a preferred embodiment has a structure containing α-Fe nanocrystal grains dispersed at a high density and also containing an amorphous phase between the grains. Although not particularly limited, the soft magnetic alloy material containing nanocrystal grains may have a crystallinity of, for example, about 20% or more, more specifically, about 30% or more. The crystallinity can be calculated by the X-ray diffractometry (that is, the crystallinity can be calculated based on an X-ray diffraction spectrum of the soft magnetic alloy material).

The nanocrystalline soft magnetic alloy material of the present disclosure has a Fe-based alloy composition, and in particular, has an alloy composition of Fe_{100-a-b-c-d-e-f}M1ₐP_{b}Cu_{c}Co_{d}NiₑM2_{f}. In such an alloy composition, M1 is at least one element selected from the group consisting of Si, B, and C, and M2 is at least one element selected from the group consisting of V, Zr, Nb, Mo, Hf, Ta, W, Sn, Bi, and In. Preferably, a, b, c, d, e, and f satisfy 3≤a≤20, 1≤b≤10, 0.1≤c≤1.5, 0≤d≤5, 0≤e≤5, and 0≤f≤3.

In other words, the nanocrystalline soft magnetic alloy material of the present disclosure has an alloy composition in which part of Fe is substituted with the above-mentioned element species at the above-mentioned ratio. Such an alloy composition may directly or indirectly contribute to the corrosion resistance and saturation magnetic flux density of the soft magnetic alloy material. The alloy composition of the soft magnetic alloy material of the present disclosure can be understood or identified by the ICP emission spectroscopy and/or carbon content analysis (preferably, an infrared absorption method after combustion). For a clearer understanding of the present disclosure, an ICP emission spectrometer used is a spectrometer manufactured by Thermo Fisher Scientific K.K. (model iCAP6300), and a carbon content analyzer used is an analyzer manufactured by HORIBA, Ltd. (EMIA-920V2/FA).

The nanocrystalline soft magnetic alloy material of the present disclosure has features at least in terms of a surface region thereof. Specifically, a surface region of the nanocrystalline soft magnetic alloy material, which extends from a surface of the nanocrystalline soft magnetic alloy material to a depth of 30 nm, contains an average of 29 atom % or more of an O element. Although not particularly limited, such O element may be present in the form of an oxide in the soft magnetic alloy material. In other words, in a local region extending from the outermost surface of the soft magnetic alloy material to the depth of 30 nm, an oxide corresponding to about 29 atom % or more of an O element on average in the region (the surface region extending from a depth of 0 nm to the depth of 30 nm) may be present. Such features of the surface region are likely to result in alloys that are preferred in terms of both the corrosion resistance and the saturation magnetic flux density. Therefore, a magnetic component containing the nanocrystalline soft magnetic alloy material of the present disclosure can have high reliability while exhibiting desired magnetic characteristics.

The “average content (atom %)” mentioned directly or indirectly herein is understood by measuring the concentration distribution of the relevant element from the surface toward the inside (in particular, the center) of the soft magnetic alloy material. As for the O element, the “average content (atom %)” is understood through the measurement of the concentration distribution of the O element from the outermost surface to the inside of the soft magnetic alloy material by X-ray photoelectron spectroscopy (XPS). In other words, the “average content (atom %)” as used herein broadly means a value measured according to such X-ray photoelectron spectroscopy. More specifically, the average content refers to a value obtained using an X-ray photoelectron spectrometer (model PHI-5000 VersaProbe manufactured by ULVAC-PHI, Inc.) by performing ion sputtering and XPS semi-quantitative analysis alternately (in particular, the average content refers to an average of measured values at 20 arbitrary points in the surface, the points being spaced apart at a measurement interval of 1.5 nm in the depth direction).

The average content (atom %) of the O element in the surface region (in particular, the surface region extending from the outermost surface to the depth of 30 nm) of the nanocrystalline soft magnetic alloy material is about 29 atom % or more, and may be, for example, about 30 atom % or more, or about 35 atom % or more. The upper limit of the average content (atom %) of the O element in the surface region (in particular, the local surface region extending from the outermost surface to the depth of 30 nm) is not particularly limited, and may be, for example, about 70 atom %, for example, about 69 atom %, about 68 atom %, about 60 atom %, about 55 atom %, or about 50 atom %.

In a preferred embodiment, M1 in the alloy composition of the nanocrystalline soft magnetic alloy material includes at least Si. In the nanocrystalline soft magnetic alloy material of the present disclosure, the content of the Si element is further reduced. A lower content of Si achieves a higher saturation magnetic flux density. Meanwhile, although a lower content of Si may lower the corrosion resistance, in the present disclosure, the corrosion resistance is not undesirably impaired and a high saturation magnetic flux density and high corrosion resistance can be compatible because the surface region of the nanocrystalline soft magnetic alloy material contains a certain amount or more of the O element. For example, the content of the Si element in the nanocrystalline soft magnetic alloy material of the present disclosure is about 0.5 atom % or more and about 20 atom % or less (i.e., from about 0.5 atom % to about 20 atom %) based on the total alloy material, and is, as an example, about 0.5 atom % or more and about 10 atom % or less (i.e., from about 0.5 atom % to about 10 atom %).

The Si element may, for example, be contained at least in the surface region of the soft magnetic alloy material. In such a case, the surface region of the nanocrystalline soft magnetic alloy material contains at least the O element and the Si element. In particular, the surface region extending from the outermost surface of the soft magnetic alloy material to the depth of 30 nm may contain at least the O element and the Si element. This means that the surface region extending to the depth of 30 nm contains an average of 29 atom % or more of the O element as described above, and the surface region also contains the Si element. The Si element in the surface region may directly or indirectly contribute to the improvement of corrosion resistance. Without wishing to be bound by a particular theory, it is presumed that the Si element forms a passivation film (for example, a SiO₂ film) in the surface region (in particular, the surface region extending from the outermost surface to the depth of 30 nm) of the soft magnetic alloy material to contribute to the improvement of corrosion resistance. In addition, presence of silicon (Si) in the alloy composition can promote amorphous formation, so that an amorphous phase structured together with crystal grains is readily introduced into the soft magnetic alloy material.

The “corrosion resistance” as used herein broadly means rust-free or low-rust characteristics of the soft magnetic alloy material exhibited at the surface of the soft magnetic alloy material. In a narrow sense, the “corrosion resistance” means rust-free or low-rust characteristics of the surface of the soft magnetic alloy material in terms of an index indicating that the coercive force of the soft magnetic alloy material, when the soft magnetic alloy material is exposed to an acidic reagent, does not excessively increase to an undesirable extent.

The nanocrystalline soft magnetic alloy material of the present disclosure has, in particular, corrosion resistance as understood according to the following salt spray test. More specifically, the nanocrystalline soft magnetic alloy material of the present disclosure has corrosion resistance in that the nanocrystalline soft magnetic alloy material satisfies, as for “coercive force Hc₁ before salt spraying” and “coercive force Hc₂ after salt spraying”, Hc₁≤70 A/m and Hc₂≤900 A/m (preferably, Hc₂≤600 A/m).

Salt Spray Test

A nanocrystalline soft magnetic alloy material in the form of a ribbon (5 mm×5 mm, average thickness: 23 μm) is used as a specimen. The coercive force of the specimen is measured with an automatic coercive force meter (model K-HC1000 manufactured by Tohoku Steel Co., Ltd.). The measurement itself of the coercive force using the automatic coercive force meter follows “Measurement of coercive force Hc” described later. The coercive force obtained at this stage is referred to as the “coercive force Hc₁ before salt spraying”. Then, the specimen is subjected to a salt spray test, and the coercive force is similarly measured to obtain Hc₂. Specifically, the specimen is subjected to a salt spray test under the conditions of a salt spray temperature of 35° C., a spray amount of 1.5 mL/h, a salt water concentration of 5 wt %, a humidity of 100% RH, and a test time of 24 hours. After the salt spray test, the coercive force of the specimen is measured with the above-mentioned automatic coercive force meter, and the obtained coercive force is referred to as the “coercive force Hc₂ after salt spraying”.

Meanwhile, the nanocrystalline soft magnetic alloy material of the present disclosure has a more preferred saturation magnetic flux density (Bs), and preferably has a saturation magnetic flux density of 1.40 T or more, for example, 1.50 T or more or 1.60 T or more. Since the nanocrystalline soft magnetic alloy material of the present disclosure has a higher saturation magnetic flux density while exhibiting preferred corrosion resistance as described above, the nanocrystalline soft magnetic alloy material may lead to miniaturization of a magnetic component containing the nanocrystalline soft magnetic alloy material. The upper limit of the saturation magnetic flux density of the nanocrystalline soft magnetic alloy material is not particularly limited, and is, for example, about 1.90 T (further, for example, 1.80 T or 1.70 T).

The “saturation magnetic flux density (Bs)” as used herein refers to a value measured using a Vibrating-Sample Magnetometer (VSM). More specifically, the value of Bs obtained according to the following procedure corresponds to the value of the saturation magnetic flux density in the present disclosure.

Measurement of Saturation Magnetic Flux Density Bs

A nanocrystalline soft magnetic alloy material in the form of a ribbon (6.3 mm×8.5 mm, average thickness: 23 μm) is used as a specimen. First, the value of the saturation magnetization of the specimen is measured using a VSM (model VSM-5 manufactured by Toei Industry Co., Ltd.). More specifically, the value of the saturation magnetization when an external magnetic field of 10 KOe is applied to the specimen is measured using the VSM. Then, the saturation magnetic flux density Bs is obtained from the measured saturation magnetization value using the true density value of the specimen measured by the Archimedes method.

When M1 in the alloy composition of the soft magnetic alloy material includes at least Si, based on 100 parts by mole in total of the alloy composition, the amount of the Si element is preferably 0.4 parts by mole or more and 10 parts by mole or less (i.e., from 0.4 parts by mole to 10 parts by mole), more preferably 0.5 parts by mole or more and 5 parts by mole or less (i.e., from 0.5 parts by mole to 5 parts by mole), still more preferably 1 part by mole or more and 3 parts by mole or less (i.e., from 1 part by mole to 3 parts by mole). Since a soft magnetic alloy material more preferred in terms of both the saturation magnetic flux density and the corrosion resistance is readily obtained, the soft magnetic alloy material is more likely to have a lower coercive force Hc. Specifically, the Hc of the soft magnetic alloy material is preferably about 60 A/m or less, more preferably 50 A/m or less, and may be 40 A/m or less or 30 A/m or less, for example.

The value of the “coercive force Hc” as used herein means a value obtained according to the following procedure.

Measurement of Coercive Force Hc

First, a ribbon (average thickness: 23 μm) of a soft magnetic alloy material is processed into a 5 mm×5 mm piece. Then, the processed soft magnetic alloy ribbon piece is attached to an alumina plate (10 mm×10 mm×2 mm) to prepare a specimen. The specimen is placed on a sample stage, and the coercive force is measured with an automatic coercive force meter (model K-HC1000 manufactured by Tohoku Steel Co., Ltd.).

In a preferred embodiment, the nanocrystalline soft magnetic alloy material of the present disclosure has a feature also in terms of the phosphorus (P) element. Specifically, the surface region of the soft magnetic alloy material contains the P element. It is preferred that the surface region of the nanocrystalline soft magnetic alloy material contain at least the O element and the P element. This is because the P element in the surface region together with the O element may directly or indirectly contribute to the improvement of corrosion resistance. In particular, when M1 in the alloy composition of the soft magnetic alloy material includes at least Si, the surface region of the soft magnetic alloy material preferably contains the P element together with the Si element. Therefore, the surface region of the nanocrystalline soft magnetic alloy material according to the preferred embodiment contains at least the O element, the Si element, and the P element. In particular, the surface region extending from the outermost surface of the nanocrystalline soft magnetic alloy material to the depth of 30 nm preferably contains the

P element together with the O element and the Si element. This means that the surface region extending to the depth of 30 nm contains an average of 29 atom % or more of the O element as described above, and the surface region also contains the P element together with the Si element. Accordingly, the soft magnetic alloy material is more likely to have more preferred corrosion resistance while further maintaining the saturation magnetic flux density. This is because the P element in the surface region may directly or indirectly contribute to the improvement of corrosion resistance.

For example, in the nanocrystalline soft magnetic alloy material according to a preferred embodiment, a surface region of the nanocrystalline soft magnetic alloy material, which extends from the surface of the nanocrystalline soft magnetic alloy material to a depth of 100 nm, contains an average of 0.1 atom % or more of the P element. Although not particularly limited, such P element may be present in the form of an oxide in the surface region of the soft magnetic alloy material. In other words, in the surface region extending from the outermost surface of the soft magnetic alloy material to the depth of 100 nm, an oxide involving the P element may be present, the P element being in an amount of about 0.1 atom % or more on average in the region. Due directly or indirectly to such a feature of the surface region relating to the P element, corrosion resistance may be further improved. In a more preferred embodiment, the surface region of the nanocrystalline soft magnetic alloy material, which extends from the surface of the nanocrystalline soft magnetic alloy material to the depth of 100 nm, contains an average of 0.1 atom % or more and an average of 0.9 atom % or less (i.e., from an average of 0.1 atom % to an average of 0.9 atom %) of the P element. More preferably, the surface region of the nanocrystalline soft magnetic alloy material, which extends from the surface of the nanocrystalline soft magnetic alloy material to the depth of 100 nm, contains an average of 0.3 atom % or more and an average of 0.7 atom % or less (i.e., from an average of 0.3 atom % to an average of 0.7 atom %) of the P element, particularly preferably an average of 0.5 atom % or more and an average of 0.6 atom % or less (i.e., from an average of 0.5 atom % to an average of 0.6 atom %) of the P element.

In the nanocrystalline soft magnetic alloy material according to a preferred embodiment, the average content of the P element is different between the surface region and an inner region. In other words, the average content of the P element in the surface region of the soft magnetic alloy material and the average content of the P element in the inner region (a region located deeper inside of the surface region) of the soft magnetic alloy material are not close to each other but are largely different. For example, the average content (atom %) of the P element in the surface region is lower than the average content (atom %) of the P element in a central region of the soft magnetic alloy material, where the surface region extends from the outermost surface of the nanocrystalline soft magnetic alloy material to the depth of 100 nm, and the central region is located deeper inside of the surface region. Conversely, the average content (atom %) of the P element in the central region of the soft magnetic alloy material is higher than the average content (atom %) of the P element in the surface region, where the central region is located deeper inside of the outermost surface of the nanocrystalline soft magnetic alloy material by 100 nm (but not including 100 nm), and the surface region extends from the outermost surface to the depth of 100 nm. More specifically, the ratio of the “average content of the P element in the surface region” to the “average content of the P element in the central region” (that is, the value of “average content of the P element in the surface region”/“average content of the P element in the central region”) is preferably 0.02 to 0.5, more preferably 0.04 to 0.3, still more preferably 0.07 to 0.13. Without wishing to be bound by a particular theory, the P element in the surface region can have a preferred effect particularly on the corrosion resistance of the soft magnetic alloy material, while the P element in the central region can have a preferred effect particularly on the magnetic characteristics of the soft magnetic alloy material. For example, the P element in the central region of the nanocrystalline soft magnetic alloy material may contribute to a lower coercive force.

The P element can also play a role in stabilizing the amorphous matrix. Therefore, an average of 0.1 atom % or more of the P element in the surface region of the nanocrystalline soft magnetic alloy material is likely to stabilize the amorphous matrix and provide high corrosion resistance. If the content of the P element is too high, however, the amorphous forming capability is conversely reduced, and the coercive force tends to be reduced. Therefore, it is preferred that the content of the P element be 10 atom % or less based on the total soft magnetic alloy material.

The “central region” as used herein broadly means a region corresponding to the center of the relevant nanocrystalline soft magnetic alloy material (therefore, in a nanocrystalline soft magnetic alloy material in a powder form, the central region means a region corresponding to the center of each of the X direction, the Y direction, and the Z direction, whereas in a nanocrystalline soft magnetic alloy material in a ribbon form, the central region means a region corresponding to the center of the ribbon in the thickness direction and the width direction). In a narrow sense, the “central region” refers to a region extending from a depth of 0.25×d from the outermost surface of the soft magnetic alloy material to a depth of 0.75×d therefrom, where d is the thickness of the ribbon or the particle size of the powder.

The total content of the P element in the nanocrystalline soft magnetic alloy material may be in a certain range. For example, in the soft magnetic alloy material of the present disclosure, the amount of the P element may be 1 part by mole or more and 10 parts by mole or less (i.e., from 1 part by mole to 10 parts by mole), for example, 2 parts by mole or more and 10 parts by mole or less (i.e., from 2 parts by mole to 10 parts by mole). That is, in the above-mentioned alloy composition Fe_{100-a-b-c-d-e-f}M1ₐP_{b}Cu_{c}Co_{d}NiₑM2_{f}, based on 100 parts by mole in total of the alloy composition, the amount of the P element may be 1 part by mole or more and 10 parts by mole or less (i.e., from 1 part by mole to 10 parts by mole), for example, 2 parts by mole or more and 10 parts by mole or less (i.e., from 2 parts by mole to 10 parts by mole) (that is, 1≤b≤10, for example, 2≤b≤10). In such a case, a lower coercive force Hc is readily achieved. More specifically, the Hc of the nanocrystalline soft magnetic alloy material of the present disclosure can be about 40 A/m or less, for example, 30 A/m or less.

The nanocrystalline soft magnetic alloy material of the present disclosure exhibits preferred corrosion resistance, but the iron (Fe) content is not so low that the saturation magnetic flux density is undesirably reduced. For example, a certain amount of Fe may be present in the surface region of the soft magnetic alloy material. More specifically, the surface region extending from the outermost surface of the nanocrystalline soft magnetic alloy material to the depth of 30 nm may contain an average of 30 atom % or more of the Fe element. In other words, in the surface region extending from the outermost surface of the nanocrystalline soft magnetic alloy material to the depth of 30 nm, about 30 atom % or more of the Fe element on average in the region may be present. Such a feature of the surface region may directly or indirectly contribute to the characteristics of the soft magnetic alloy material in which the corrosion resistance and the saturation magnetic flux density are compatible. From a certain viewpoint, it can be said that the nanocrystalline soft magnetic alloy material of the present disclosure, while having preferred corrosion resistance, has a preferably maintained saturation magnetic flux density in terms of the amount of Fe.

In the nanocrystalline soft magnetic alloy material of the present disclosure, the surface region contains the Fe element and also contains the O element as described above, and more preferably, the surface region also contains the Si element. In such a case, the surface (for example, the outermost surface) of the soft magnetic alloy material may contain iron oxide, silicon oxide, and/or a composite oxide of iron and silicon. In other words, the iron (Fe) element and the silicon (Si) element in the surface of the nanocrystalline soft magnetic alloy material are at least partially present in the form of respective oxides, or form a composite oxide of the elements. Such a feature of the surface region may directly or indirectly contribute to the characteristics of both a higher saturation magnetic flux density and higher corrosion resistance. Iron oxide, silicon oxide, and/or a composite oxide of iron and silicon may be present, for example, as a precipitate on the surface of the nanocrystalline soft magnetic alloy material.

In a preferred embodiment, the nanocrystalline soft magnetic alloy material of the present disclosure has a feature also in terms of incorporation of a copper (Cu) element. Specifically, in the soft magnetic alloy material, the difference in the average content of the Cu element between the surface region and the inner region is relatively small. In other words, the average content of the Cu element in the surface region of the soft magnetic alloy material and the average content of the Cu element in the inner region (a region located deeper inside of the surface region) of the soft magnetic alloy material are close to each other rather than being largely different. For example, the relative ratio between the maximum content (atom %) of the Cu element in the surface region and the maximum content (atom %) of the Cu element in the inner region is within a range of 1 or more and 2.5 or less (i.e., from 1 to 2.5), where the surface region extends from the surface of the nanocrystalline soft magnetic alloy material to a depth of 20 nm, and the inner region extends from the depth of 20 nm (but not including 20 nm) to a depth of 40 nm and is located deeper inside of the surface region. More specifically, in the soft magnetic alloy material, as for Q1ₘₐₓ that is the maximum content (maximum value in atom %) of the Cu element in the surface region, which extends from the surface of the soft magnetic alloy material to the depth of 20 nm, and Q2ₘₐₓ that is the maximum content (maximum value in atom %) of the Cu element in the inner region, which extends from the depth of 20 nm (but not including 20 nm) from the surface of the soft magnetic alloy material to the depth of 40 nm therefrom, the value of at least one of Q1ₘₐₓ/Q2ₘₐₓ and Q2ₘₐₓ/Q1ₘₐₓ falls within the range of 1 or more and 2.5 or less (i.e., from 1 to 2.5), more preferably 1 or more and 2 or less (i.e., from 1 to 2), still more preferably 1 or more and 1.5 or less (i.e., from 1 to 1.5) (for example, 1 or more and 1.4 or less (i.e., from 1 to 1.4), or 1 or more and 1.3 or less (i.e., from 1 to 1.3)). Such a feature of the Cu content may advantageously contribute to the characteristics of the soft magnetic alloy material in which the saturation magnetic flux density and the corrosion resistance are compatible.

In the nanocrystalline soft magnetic alloy material of the present disclosure, the Cu element can also play a role in stabilizing the crystal structure. Therefore, the amount of the Cu element in the nanocrystalline soft magnetic alloy material of the present disclosure may be 0.1 atom % or more and 1.5 atom % or less (i.e., from 0.1 atom % to 1.5 atom %) based on the total alloy material, whereby the nanocrystal structure is readily obtained stably.

M1 in the alloy composition of the soft magnetic alloy material of the present disclosure can play at least a role in amorphous formation. In other words, when the alloy composition contains at least one element selected from the group consisting of silicon (Si), boron (B), and carbon (C), the amorphous phase structured together with the crystal grains is readily introduced into the soft magnetic alloy material. For example, a content of M1 of 3 atom % or more based on the total alloy material may readily provide amorphous forming capability. Meanwhile, if the content of M1 is excessively increased, the saturation magnetic flux density tends to be reduced, so that the content of M1 may be, for example, 20 atom % or less.

M2 in the alloy composition of the soft magnetic alloy material of the present disclosure may contribute to reduction of the coercive force. That is, an alloy composition containing at least one element selected from the group consisting of vanadium (V), zirconium (Zr), niobium (Nb), molybdenum (Mo), hafnium (Hf), tantalum (Ta), tungsten (W), tin (Sn), bismuth (Bi), and indium (In) tends to readily reduce the coercive force. In the alloy composition of Fe_{100-a-b-c-d-e-f}M1ₐP_{b}Cu_{c}Co_{d}NiₑM2_{f}, 0≤f≤3 is preferably satisfied. This is because if f exceeds 3, the saturation magnetic flux density (Bs) tends to be reduced. For example, if f exceeds 3, the Bs may be less than 1.40 T.

Cobalt (Co) in the alloy composition of the soft magnetic alloy material of the present disclosure may preferably contribute to the coercive force. In this regard, in the alloy composition of Fe_{100-a-b-c-d-e-f}M1ₐP_{b}Cu_{c}Co_{d}NiₑM2_{f}, 0≤d≤5 is preferably satisfied. This is because if d exceeds 5, the coercive force tends to exceed 70 A/m. Without wishing to be bound by a particular theory, it is considered that one of the factors of the high coercive force is that an increase of the Co element amount may increase the magnetostriction constant.

Nickel (Ni) in the alloy composition of the soft magnetic alloy material of the present disclosure may preferably contribute to the saturation magnetic flux density. In this regard, in the alloy composition of Fe_{100-a-b-c-d-e-f}M1ₐP_{b}Cu_{c}Co_{d}NiₑM2_{f}, 0≤e≤5 is preferably satisfied. This is because if e exceeds 5, the saturation magnetic flux density (Bs) tends to be reduced. For example, if e exceeds 5, the Bs is likely to be less than 1.40 T. Without wishing to be bound by a particular theory, it is considered that one of the factors of the low Bs is that an increase of the Ni element amount may reduce the magnetic moment per atom.

In the soft magnetic alloy material of the present disclosure, although not particularly limited, M1 in the alloy composition may include at least B. That is, the nanocrystalline soft magnetic alloy material may contain a boron (B) element. For example, based on 100 parts by mole in total of the alloy composition, the amount of the B element may be 2 parts by mole or more and 12 parts by mole or less (i.e., from 2 parts by mole to 12 parts by mole) (for example, 5 parts by mole or more and 11 parts by mole or less (i.e., from 5 parts by mole to 11 parts by mole)). Presence of the B element can promote amorphous formation, so that an amorphous phase structured together with crystal grains is readily introduced into the soft magnetic alloy material.

The nanocrystalline soft magnetic alloy material of the present disclosure is preferably a material having a regular shape. That is, the soft magnetic alloy material of the present disclosure is an alloy material having a predetermined shape. For example, the nanocrystalline soft magnetic alloy material of the present disclosure has a ribbon form or a powder form. The nanocrystalline soft magnetic alloy material is either a thin soft magnetic alloy body having a long shape or a soft magnetic alloy body provided as a powdery or granular aggregate.

By way of example only, the ribbon-formed nanocrystalline soft magnetic alloy material may have a long shape with a width dimension (short dimension) of about 1 to 10 mm (for example, 1 to 5 mm) and a thickness of about 8 to 50 μpm (for example, 10 to 40 μm or 15 to 30 μm). The soft magnetic alloy material having a ribbon form can be generally produced by a liquid quenching method using a roll device. The ribbon-formed nanocrystalline soft magnetic alloy material has flexibility, and can be continuously wound after production.

The powder-formed nanocrystalline soft magnetic alloy material may have an average particle size of, for example, about 10 to 150 μm (in some cases, 2 to 40 μm, for example). The “average particle size” referred to herein may be regarded as, for example, D50 (median diameter) for convenience. The soft magnetic alloy material having a powder form can be obtained by pulverizing the above-mentioned ribbon. For example, a powder-formed soft magnetic alloy material can be obtained by pulverization using a mechanical means such as a pin mill or a ball mill. In such a case, a nanocrystal can be precipitated by a heat treatment, and the heat treatment may be performed either before the pulverization of the ribbon or after the pulverization of the ribbon. The soft magnetic alloy material having a powder form can also be produced by an atomization method. That is, the powder may be produced by causing a molten metal of the alloy to flow out of a small hole in the bottom of a crucible, and spraying a gas or water at a high speed to the flowed out molten metal to solidify the molten metal. The powder is heat-treated to precipitate a nanocrystal, whereby a desired powder-formed soft magnetic alloy material can be obtained.

Hereinafter, a method for producing the soft magnetic alloy material according to one embodiment of the present disclosure will be described. A case where a ribbon-formed nanocrystalline soft magnetic alloy material is produced from raw material metals of a mother alloy will be described as an example.

First, raw materials of the mother alloy are prepared. One or more raw materials of the mother alloy selected from the group consisting of Fe, Si, B, a Fe—P alloy, Cu, C, Co, Ni, V, Zr, Nb, Mo, Hf, Ta, Sn, Bi, and In are each prepared. The raw materials of the mother alloy used may be commercially available products.

Then, these raw materials are weighed so as to have a desired alloy composition, and the weighed raw materials are heated to the melting point or higher to be melted in a heating furnace. The heating furnace used may be a high-frequency induction heating furnace. Subsequently, the molten material is poured into a casting mold to produce a mother alloy. The casting mold used may be a copper casting mold. After the mother alloy is obtained, the mother alloy is pulverized and put into a crucible of a liquid quenching device, and is melted by high-frequency induction heating to produce a molten metal. The atmosphere inside the liquid quenching device is preferably adjusted to the air atmosphere. Then, an inert gas (for example, an argon gas) is introduced into the crucible to discharge the molten metal from a slit hole in the bottom of the crucible, and the molten metal is quenched with a rotary roll (for example, a rotary copper roll) provided immediately below the crucible to produce an alloy ribbon.

Such an alloy ribbon is preferably subjected to a heat treatment, and a nanocrystalline alloy ribbon is finally obtained through the treatment. The heat treatment is preferably performed by infrared heating. That is, the heat treatment is preferably performed using an infrared heating system. Further, the treatment by infrared heating is preferably performed under an oxygen-containing atmosphere (for example, under an air atmosphere), and such infrared heating under an oxygen-containing atmosphere directly or indirectly contributes to “an average of 29 atom % or more of the O element in the surface region extending from the surface of the nanocrystalline soft magnetic alloy material to the depth of 30 nm”. Further, the heating rate in the infrared heating is preferably 400 to 600° C./min, the maximum temperature in the infrared heating is preferably about 300 to 500° C. (for example, 400° C.), and the holding time at the maximum temperature is preferably 0 (but not including 0) to 3600 seconds (for example, 60 seconds). In a preferred embodiment, the heat treatment is performed using a carbon plate. For example, the heat treatment may be performed by sandwiching the alloy ribbon between carbon plates and irradiating the alloy ribbon with infrared rays from above and below.

The present disclosure also provides a magnetic component containing the nanocrystalline soft magnetic alloy material. That is, the present disclosure also provides a magnetic component containing the above-mentioned nanocrystalline soft magnetic alloy material.

The magnetic component according to one embodiment of the present disclosure may be, for example, a coil component. In such a case, a magnetic core of the coil component contains the above-mentioned nanocrystalline soft magnetic alloy material. For example, the magnetic component of the present disclosure may be a coil component having the following configuration.

A coil component including a magnetic core (core) produced by winding or stacking a ribbon-formed nanocrystalline soft magnetic alloy material, and a winding wire wound around the core

A coil component including a magnetic core (core) produced by subjecting a mixture containing a powder-formed nanocrystalline soft magnetic alloy material and a resin to powder compaction, and a winding wire wound around the core

A coil component obtained by molding a mixture containing a powder-formed nanocrystalline soft magnetic alloy material and a resin, and then integrally molding the resulting molded product with a winding wire

Such a magnetic component of the present disclosure contains the above-mentioned nanocrystalline soft magnetic alloy material in which the corrosion resistance and the saturation magnetic flux density are compatible at a preferred level. Therefore, the magnetic component of the present disclosure can exhibit desired magnetic characteristics even when provided as a more miniaturized component.

When the magnetic component is provided as a coil component, the nanocrystalline soft magnetic alloy material is used in a magnetic core. A magnetic core containing a resin material will be described in detail. Such a magnetic core is formed from a composite material containing the powder-formed nanocrystalline soft magnetic alloy material of the present disclosure (hereinafter also simply referred to as a “nanocrystalline soft magnetic powder”) and a resin. The resin used may be, for example, an epoxy resin, a phenol resin, and/or a silicone resin. By way of example only, the content of the nanocrystalline soft magnetic powder in the composite material may be 60 vol % or more and 90 vol % or less (i.e., from 60 vol % to 90 vol %). This is because a content of the nanocrystalline soft magnetic powder within the above-mentioned range facilitates the provision of a magnetic core having excellent magnetic characteristics. The size and shape of the magnetic core are not particularly limited, and can be appropriately decided according to the intended use. The magnetic core may be, for example, a toroidal core.

A method for producing such a magnetic core includes a step of mixing a nanocrystalline soft magnetic powder with a resin such as an epoxy resin, a phenol resin, and/or a silicone resin and molding the resulting mixture to produce a molded article, and a step of heating the molded article. The molded article can be obtained by press-molding the mixture containing the nanocrystalline soft magnetic powder and the resin. The size and shape of the molded article are not particularly limited, and can be appropriately decided according to the size and shape of the desired magnetic core. The heating temperature of the molded article can be appropriately decided according to, for example, the type of the resin used.

The coil component includes a magnetic core and a coil conductor (winding wire) wound around the magnetic core. The coil conductor itself can be formed by winding a metal wire such as an enamel-coated copper wire around a magnetic core. The winding of the metal wire itself may be performed by a common procedure.

The embodiments of the present disclosure have been described above, but the embodiments are merely typical examples. Therefore, the present disclosure is not limited to the above-mentioned embodiments, and those skilled in the art will readily understand that various aspects can be considered without changing the spirit of the present disclosure.

For example, the description has been given of the nanocrystalline soft magnetic alloy material having the alloy composition of “Fe_{100-a-b-c-d-e-f}M1ₐP_{b}Cu_{c}Co_{d}NiₑM2_{f}”, but presence of a very small amount of components that may inevitably or incidentally mix during the production process of the nanocrystalline soft magnetic alloy material is acceptable. For example, presence of such inevitable or incidental components is acceptable to the extent that the amount of such components is 1% by weight or less based on the total nanocrystalline soft magnetic alloy material as long as the desired effects of the present application are exhibited.

### EXAMPLES

Verification tests were performed in connection with the present disclosure. Specifically, a test was performed to confirm the characteristics of the nanocrystalline soft magnetic alloy material.

(Production of Nanocrystalline Soft Magnetic Alloy Materials)

First, as raw materials of the mother alloy, one or more raw materials selected from the group consisting of Fe, Si, B, a Fe—P alloy, Cu, C, Co, Ni, V, Zr, Nb, Mo, Hf, Ta, Sn, Bi, and In were each prepared. The raw materials of the mother alloy used were commercially available products.

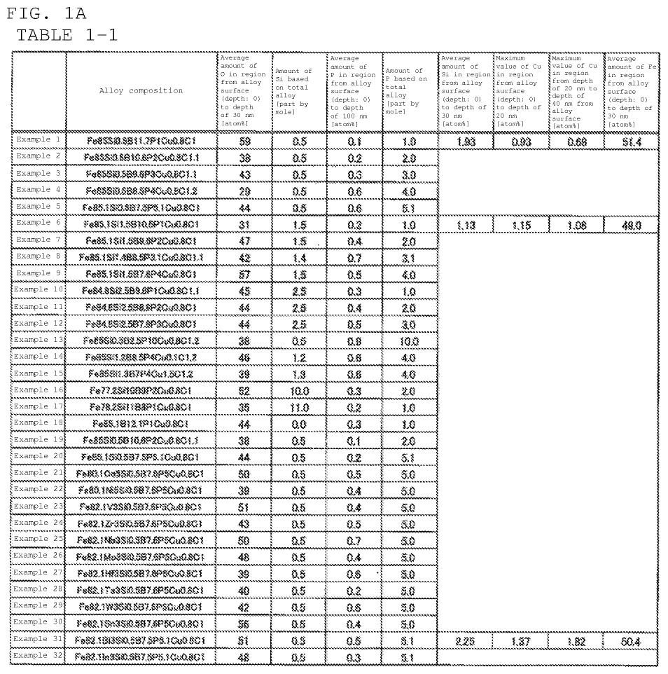

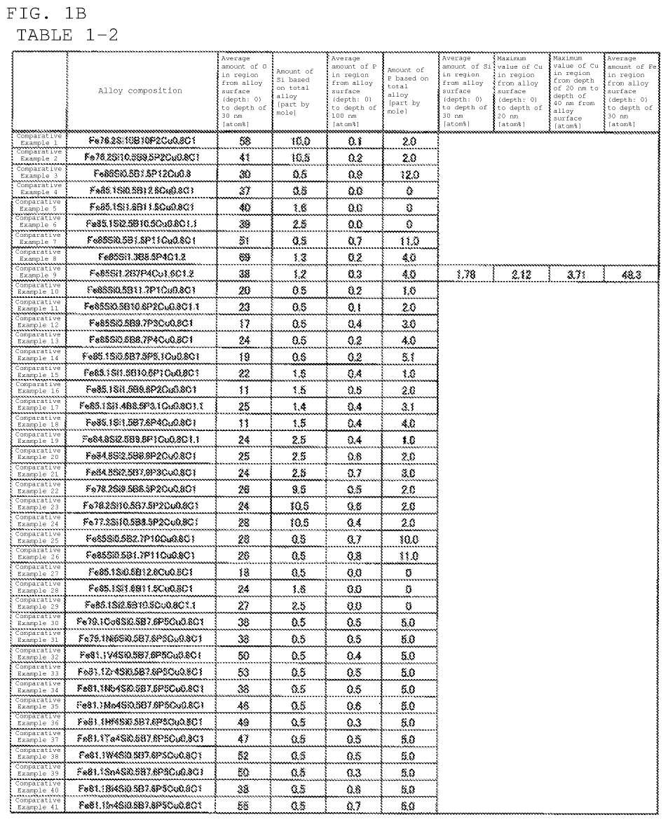

Then, these raw materials were weighed so as to have the alloy compositions shown in Tables 1-1 and 1-2 (FIGS. 1A and 1B), and the weighed raw materials were heated to the melting point or higher to be melted in a heating furnace. The heating furnace used was a high-frequency induction heating furnace. Subsequently, the molten material was poured into a copper casting mold to produce a mother alloy. After the mother alloy was obtained, the mother alloy was pulverized into a size of about 1 cm using a jaw crusher and put into a crucible of a liquid quenching device, and was melted by high-frequency induction heating to produce a molten metal. The atmosphere inside the liquid quenching device was adjusted to the air atmosphere. Then, an argon gas was introduced into the crucible to discharge the molten metal from a slit hole in the bottom of the crucible, and the molten metal was quenched with a rotary copper roll provided immediately below the crucible to produce an alloy ribbon (average thickness: about 23 μm).

The alloy ribbon was subjected to a heat treatment using an infrared heating system (model RTA4000 manufactured by ADVANCE RIKO, Inc.), whereby a nanocrystalline soft magnetic alloy material was obtained. The heating rate in the infrared heating was preferably within the range of 400 to 600° C./min The maximum temperature in the infrared heating was about 400° C., and the holding time at the maximum temperature was 60 seconds. In particular, the heat treatment was performed by sandwiching the alloy ribbon between carbon plates and irradiating the alloy ribbon with infrared rays from above and below.

(Evaluation of Nanocrystalline Soft Magnetic Alloy Materials)

As for the ribbon-formed nanocrystalline soft magnetic alloy materials obtained above, the average grain size was estimated using a transmission electron microscope (TEM), and the Scherrer equation from the X-ray diffractometry, and formation of α-Fe crystal grains having a grain size of 20 to 50 nm was confirmed.

The nanocrystalline soft magnetic alloy materials were subjected to the ICP emission spectroscopy and carbon content analysis (an infrared absorption method after combustion), and it was found that the nanocrystalline soft magnetic alloy materials had compositions shown in Tables 1-1 and 1-2 (FIGS. 1A and 1B).

The concentration distribution of elements was measured by X-ray photoelectron spectroscopy (XPS, model PHI-5000 VersaProbe manufactured by ULVAC-PHI, Inc.) from the surface of the free surface (free solidified surface) of each nanocrystalline soft magnetic alloy material toward the inside thereof.

The saturation magnetic flux density of the nanocrystalline soft magnetic alloy materials was measured using a Vibrating-Sample Magnetometer (VSM, model VSM-5 manufactured by Toei Industry Co., Ltd.). In particular, the value of the saturation magnetization of the ribbon-formed nanocrystalline soft magnetic alloy materials each processed into a 6.3 mm×8.5 mm piece, to which an external magnetic field of 10 KOe was applied, was measured. The value of the saturation magnetization was converted to the saturation magnetic flux density Bs using the value of the true density of the nanocrystalline soft magnetic alloy material obtained by the Archimedes method.

In order to evaluate the corrosion resistance, the coercive force of the nanocrystalline soft magnetic alloy materials was also measured using an automatic coercive force meter (model K-HC1000 manufactured by Tohoku Steel Co., Ltd.). The ribbon-formed nanocrystalline soft magnetic alloy materials were each processed into a 5 mm×5 mm piece, and the piece was attached to an alumina plate (10 mm×10 mm×2 mm). The resulting product was placed on a sample stage, and the coercive force was measured. The coercive force obtained in the measurement is referred to as the “coercive force Hc₁ before salt spraying”.

The nanocrystalline soft magnetic alloy materials after the measurement of the coercive force Hc₁ were subjected to a salt spray test. Specifically, the nanocrystalline soft magnetic alloy materials were subjected to a salt spray test under the conditions of a salt spray temperature of 35° C., a spray amount of 1.5 mL/h, a salt water concentration of 5 wt %, a humidity of 100% RH, and a test time of 24 hours. Then, the coercive force was measured again using the Hc meter as described above. The coercive force obtained in the measurement is referred to as the “coercive force Hc₂ after salt spraying”.

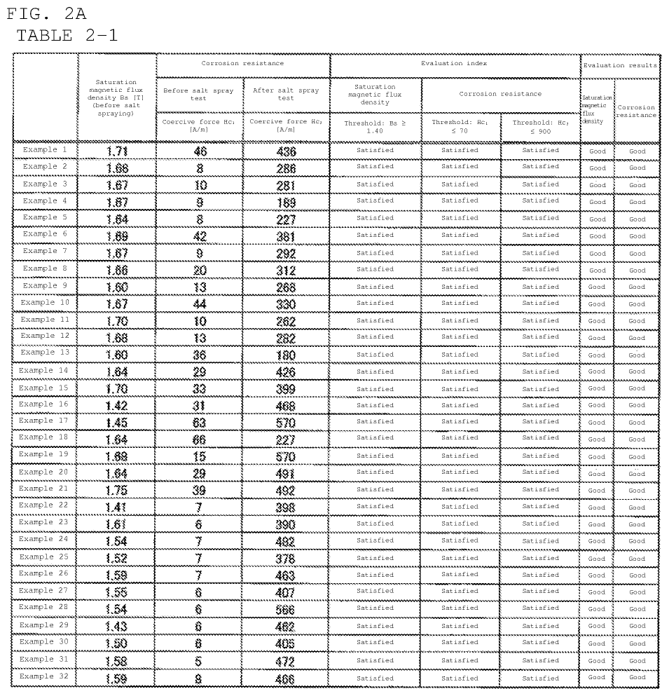

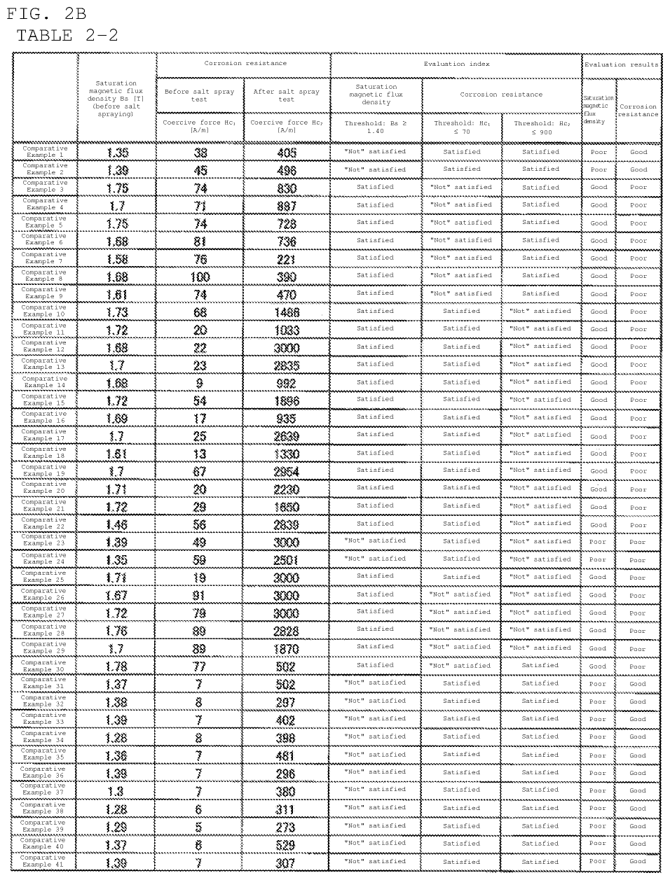

The results of “Measurement of saturation magnetic flux density Bs” and “Salt spray test” (corrosion resistance) are shown in Tables 2-1 and 2-2 (FIGS. 2A and 2B).

In the tables, Examples 1 to 32 are within the scope of the present disclosure, and Comparative Examples 1 to 41 are outside of the scope of the present disclosure. More specifically, nanocrystalline soft magnetic alloy materials that have an alloy composition of Fe_{100-a-b-c-d-e-f}M1ₐP_{b}Cu_{c}Co_{d}NiₑM2_{f} (wherein M1 is at least one element selected from the group consisting of Si, B, and C; M2 is at least one element selected from the group consisting of V, Zr, Nb, Mo, Hf, Ta, W, Sn, Bi, and In; and a, b, c, d, e, and f satisfy 3≤a≤20, 1≤b≤10, 0.1≤c≤1.5, 0≤d≤5, 0≤e≤5, and 0≤f≤3), and in which a surface region contains an average of 29 atom % or more of an O element, the surface region extending from a surface of the nanocrystalline soft magnetic alloy material to a depth of 30 nm, correspond to Examples 1 to 32, and nanocrystalline soft magnetic alloy materials that do not satisfy the above-mentioned requirements correspond to Comparative Examples 1 to 41.

Referring to Tables 1-1 and 1-2 and Tables 2-1 and 2-2, the following matters were understood.

The nanocrystalline soft magnetic alloy materials according to Comparative Examples 1 to 41 do not satisfy both the requirements that “they have an alloy composition of Fe_{100-a-b-c-d-e-f}M1ₐP_{b}Cu_{c}Co_{d}NiₑM2_{f} (wherein M1 is at least one element selected from the group consisting of Si, B, and C; M2 is at least one element selected from the group consisting of V, Zr, Nb, Mo, Hf, Ta, W, Sn, Bi, and In; and a, b, c, d, e, and f satisfy 3≤a≤20, 1≤b≤10, 0.1≤c≤1.5, 0≤d≤5, 0≤e≤5, and 0≤f≤3)” and that “a surface region of the nanocrystalline soft magnetic alloy material, which extends from a surface of the nanocrystalline soft magnetic alloy material to a depth of 30 nm, contains an average of 29 atom % or more of an O element”, and the saturation magnetic flux density and the corrosion resistance are not compatible at a desired level.

Meanwhile, in the nanocrystalline soft magnetic alloy materials according to Examples 1 to 32 that satisfy the above-mentioned alloy composition and also satisfy the requirement that “a surface region of the nanocrystalline soft magnetic alloy material, which extends from a surface of the nanocrystalline soft magnetic alloy material to a depth of 30 nm, contains an average of 29 atom % or more of an O element”, the saturation magnetic flux density and the corrosion resistance are compatible at a preferred level.

In particular, in Examples 1, 6, and 31, it is shown that the surface region (the surface region extending from the outermost surface to the depth of 30 nm) contains a Si element. Therefore, a nanocrystalline soft magnetic alloy material in which the saturation magnetic flux density and the corrosion resistance are compatible may be an alloy material in which the surface region contains at least an O element and a Si element.

In Examples 1 to 16 and 18 to 32, the amount of the Si element is 0.5 parts by mole or more and 10 parts by mole or less (i.e., from 0.5 parts by mole to 10 parts by mole) based on 100 parts by mole in total of the alloy composition. Therefore, a nanocrystalline soft magnetic alloy material in which the saturation magnetic flux density and the corrosion resistance are compatible may be an alloy material having an alloy composition in which the amount of the Si element is 0.5 parts by mole or more and 10 parts by mole or less (i.e., from 0.5 parts by mole to 10 parts by mole).

In Examples 1 to 32, the surface region contains a P element. Therefore, a nanocrystalline soft magnetic alloy material in which the saturation magnetic flux density and the corrosion resistance are compatible may be an alloy material in which the surface region contains at least an O element and a P element.

In Examples 1 to 32, the content of the P element in the surface region (in particular, the content of the P element in the surface region extending from the outermost surface to the depth of 100 nm) was 0.1 atom % or more on average. Therefore, a nanocrystalline soft magnetic alloy material in which the saturation magnetic flux density and the corrosion resistance are compatible may be an alloy material in which the surface region (the surface region extending from the surface to the depth of 100 nm) contains an average of 0.1 atom % or more of a P element.

In Examples 1 to 32, the amount of the P element is 1 part by mole or more and 10 parts by mole or less (i.e., from 1 part by mole to 10 parts by mole) (for example, 2 parts by mole or more and 10 parts by mole or less (i.e., from 2 parts by mole to 10 parts by mole) based on 100 parts by mole in total of the alloy composition. Therefore, a nanocrystalline soft magnetic alloy material in which the saturation magnetic flux density and the corrosion resistance are compatible may be an alloy material having an alloy composition in which the amount of the P element is 1 part by mole or more and 10 parts by mole or less (i.e., from 1 part by mole to 10 parts by mole) (for example, 2 parts by mole or more and 10 parts by mole or less (i.e., from 2 parts by mole to 10 parts by mole)).

The content of the P element inside of the nanocrystalline soft magnetic alloy material, in particular, the “content (atom %) of the P element in the central region of the soft magnetic alloy material located deeper inside of the surface region extending from the surface to a depth of 100 nm” is thought to be almost equal to the amount of the P element in the total alloy composition. In view of this, in Examples 1 to 32, “the average content of the P element in the surface region extending from the surface of the soft magnetic alloy material to the depth of 100 nm” is lower than “the average content of the P element in the central region of the soft magnetic alloy material located deeper inside of the surface region”. Therefore, a nanocrystalline soft magnetic alloy material in which the saturation magnetic flux density and the corrosion resistance are compatible may be an alloy material having such a feature of the P element content.

In particular, in Examples 1, 6, and 31, the relative ratio between the “maximum content of the Cu element in the surface region extending from the surface of the nanocrystalline soft magnetic alloy material to the depth of 20 nm” and the “maximum content of the Cu element in the inner region extending from the depth of 20 nm (but not including 20 nm) to the depth of 40 nm and is located deeper inside of the surface region” is within a range of 1 or more and 2.5 or less (i.e., from 1 to 2.5). Therefore, a nanocrystalline soft magnetic alloy material in which the saturation magnetic flux density and the corrosion resistance are compatible may be an alloy material having such a feature of the Cu element content.

In particular, in Examples 1, 6, and 31, the content of the Fe element in the surface region (in particular, the content of the Fe element in the surface region extending from the outermost surface to the depth of 30 nm) was 30 atom % or more on average. Therefore, a nanocrystalline soft magnetic alloy material in which the saturation magnetic flux density and the corrosion resistance are compatible may be an alloy material in which the surface region (the surface region extending from the surface to the depth of 30 nm) contains an average of 30 atom % or more of a Fe element.

In Examples 1, 6, and 31, it is shown that the surface region contains a Si element and a Fe element together with an O element. In view of this, it is presumed that the surface of the soft magnetic alloy material contains iron oxide, silicon oxide, and/or a composite oxide of iron and silicon. Therefore, a nanocrystalline soft magnetic alloy material in which the saturation magnetic flux density and the corrosion resistance are compatible may be an alloy material in which the surface contains iron oxide, silicon oxide, and/or a composite oxide of iron and silicon.

Finally, aspects of the present disclosure will be additionally described.

The present disclosure described above includes, but is not limited to, the following aspects.

(First Aspect)

A nanocrystalline soft magnetic alloy material containing a nanocrystal. The nanocrystalline soft magnetic alloy material has an alloy composition of Fe_{100-a-b-c-d-e-f}M1ₐP_{b}Cu_{c}Co_{d}NiₑM2_{f}. M1 is at least one element selected from the group consisting of Si, B, and C; M2 is at least one element selected from the group consisting of V, Zr, Nb, Mo, Hf, Ta, W, Sn, Bi, and In; and a, b, c, d, e, and f satisfy 3≤a≤20, 1≤b≤10, 0.1≤c≤1.5, 0≤d≤5, 0≤e≤5, and 0≤f≤3. A surface region of the nanocrystalline soft magnetic alloy material contains an average of 29 atom % or more of an O element, and the surface region extends from a surface of the nanocrystalline soft magnetic alloy material to a depth of 30 nm.

(Second Aspect)

The nanocrystalline soft magnetic alloy material according to the first aspect, wherein M1 includes at least Si, and the surface region contains at least the O element and a Si element.

(Third Aspect)

The nanocrystalline soft magnetic alloy material according to the first or second aspect, wherein M1 includes at least Si, and an amount of a Si element is 0.5 parts by mole or more and 10 parts by mole or less (i.e., from 0.5 parts by mole to 10 parts by mole) based on 100 parts by mole in total of the alloy composition.

(Fourth Aspect)

The nanocrystalline soft magnetic alloy material according to any one of the first to third aspects, wherein the surface region contains at least the O element and a P element.

(Fifth Aspect)

The nanocrystalline soft magnetic alloy material according to any one of the first to fourth aspects, wherein a surface region of the nanocrystalline soft magnetic alloy material contains an average of 0.1 atom % or more of a P element, where the surface region extends from the surface of the nanocrystalline soft magnetic alloy material to a depth of 100 nm.

(Sixth Aspect)

The nanocrystalline soft magnetic alloy material according to any one of the first to fifth aspects, wherein an amount of a P element is 2 parts by mole or more and 10 parts by mole or less (i.e., from 2 parts by mole to 10 parts by mole) based on 100 parts by mole in total of the alloy composition.

(Seventh Aspect)

The nanocrystalline soft magnetic alloy material according to any one of the first to sixth aspects, wherein an average content of a P element is lower in a surface region than in a central region of the nanocrystalline soft magnetic alloy material, where the surface region extends from the surface of the nanocrystalline soft magnetic alloy material to a depth of 100 nm, and the central region is located deeper inside of the surface region.

(Eighth Aspect)

The nanocrystalline soft magnetic alloy material according to any one of the first to seventh aspects, wherein a relative ratio between a maximum content of a Cu element in a surface region and a maximum content of the Cu element in an inner region is within a range of 1 or more and 2.5 or less (i.e., from 1 to 2.5), where the surface region extends from the surface of the nanocrystalline soft magnetic alloy material to a depth of 20 nm, and the inner region extends from the depth of 20 nm (but not including 20 nm) to a depth of 40 nm and is located deeper inside of the surface region.

(Ninth Aspect)

The nanocrystalline soft magnetic alloy material according to any one of the first to eighth aspects, wherein the surface region of the nanocrystalline soft magnetic alloy material contains an average of 30 atom % or more of a Fe element, where the surface region extends from the surface of the nanocrystalline soft magnetic alloy material to the depth of 30 nm.

(Tenth Aspect)

The nanocrystalline soft magnetic alloy material according to any one of the first to ninth aspects, wherein the surface of the nanocrystalline soft magnetic alloy material contains iron oxide, silicon oxide, and/or a composite oxide of iron and silicon.

(Eleventh Aspect)

The nanocrystalline soft magnetic alloy material according to any one of the first to tenth aspects, having a ribbon form or a powder form.

(Twelfth Aspect)

A magnetic component containing the nanocrystalline soft magnetic alloy material according to any one of the first to eleventh aspects.

The nanocrystalline soft magnetic alloy material of the present disclosure can be used as a magnetic material in various products including electronic devices. In particular, the nanocrystalline soft magnetic alloy material of the present disclosure exhibits characteristics in which a high saturation magnetic flux density and high corrosion resistance are compatible at a more preferred level than before, so that the nanocrystalline soft magnetic alloy material can be more preferably used in magnetic components of electronic devices required to have high performance

What is claimed is:

1. A nanocrystalline soft magnetic alloy material containing a nanocrystal, the nanocrystalline soft magnetic alloy material having an alloy composition of Fe_{100-a-b-c-d-e-f}M1ₐP_{b}Cu_{c}Co_{d}NiₑM2_{f},
wherein M1 is at least one element selected from the group consisting of Si, B, and C;
M2 is at least one element selected from the group consisting of V, Zr, Nb, Mo, Hf, Ta, W, Sn, Bi, and In; and
a, b, c, d, e, and f satisfy
3>a>20,
1≤b≤10,
0.1≤c≤1.5,
0≤d≤5,
0≤e≤5, and
0≤f≤3, where a, b, c, d, e, and f each correspond to number of parts by mole of each element based on 100 parts by mole in total of the alloy composition,
a surface region of the nanocrystalline soft magnetic alloy material contains an average of 29 atom % or greater of an O element, the surface region extending from a surface of the nanocrystalline soft magnetic alloy material to a depth of 30 nm.

2. The nanocrystalline soft magnetic alloy material according to claim 1, wherein
M1 includes at least Si, and the surface region contains at least the O element and a Si element.

3. The nanocrystalline soft magnetic alloy material according to claim 1, wherein
M1 includes at least Si, and an amount of a Si element is from 0.5 parts by mole or to 10 parts by mole based on 100 parts by mole in total of the alloy composition.

4. The nanocrystalline soft magnetic alloy material according to claim 1, wherein
the surface region contains at least the O element and a P element.

5. The nanocrystalline soft magnetic alloy material according to claim 1, wherein
a surface region of the nanocrystalline soft magnetic alloy material contains an average of 0.1 atom % or more of a P element, where the surface region extends from the surface of the nanocrystalline soft magnetic alloy material to a depth of 100 nm.

6. The nanocrystalline soft magnetic alloy material according to claim 1, wherein
an amount of a P element is from 2 parts by mole to 10 parts by mole based on 100 parts by mole in total of the alloy composition.

7. The nanocrystalline soft magnetic alloy material according to claim 1, wherein
an average content of a P element is lower in a surface region than in a central region of the nanocrystalline soft magnetic alloy material, where the surface region extends from the surface of the nanocrystalline soft magnetic alloy material to a depth of 100 nm, and the central region is located deeper inside of the surface region.

8. The nanocrystalline soft magnetic alloy material according to claim 1, wherein
a relative ratio between a maximum content of a Cu element in a surface region and a maximum content of the Cu element in an inner region is within a range of from 1 to 2.5, where the surface region extends from the surface of the nanocrystalline soft magnetic alloy material to a depth of 20 nm, and the inner region extends from the depth of 20 nm (but not including 20 nm) to a depth of 40 nm and is located deeper inside of the surface region.

9. The nanocrystalline soft magnetic alloy material according to claim 1, wherein
the surface region of the nanocrystalline soft magnetic alloy material contains an average of 30 atom % or more of a Fe element, where the surface region extends from the surface of the nanocrystalline soft magnetic alloy material to the depth of 30 nm.

10. The nanocrystalline soft magnetic alloy material according to claim 1, wherein
the surface of the nanocrystalline soft magnetic alloy material contains iron oxide, silicon oxide, and/or a composite oxide of iron and silicon.

11. The nanocrystalline soft magnetic alloy material according to claim 1, wherein
the nanocrystalline soft magnetic alloy material has a ribbon form or a powder form.

12. A magnetic component comprising the nanocrystalline soft magnetic alloy material according to claim 1.

13. The nanocrystalline soft magnetic alloy material according to claim 2, wherein
M1 includes at least Si, and an amount of a Si element is from 0.5 parts by mole or to 10 parts by mole based on 100 parts by mole in total of the alloy composition.

14. The nanocrystalline soft magnetic alloy material according to claim 2, wherein
the surface region contains at least the O element and a P element.

15. The nanocrystalline soft magnetic alloy material according to claim 2, wherein
a surface region of the nanocrystalline soft magnetic alloy material contains an average of 0.1 atom % or more of a P element, where the surface region extends from the surface of the nanocrystalline soft magnetic alloy material to a depth of 100 nm.

16. The nanocrystalline soft magnetic alloy material according to claim 2, wherein
an amount of a P element is from 2 parts by mole to 10 parts by mole based on 100 parts by mole in total of the alloy composition.

17. The nanocrystalline soft magnetic alloy material according to claim 2, wherein
an average content of a P element is lower in a surface region than in a central region of the nanocrystalline soft magnetic alloy material, where the surface region extends from the surface of the nanocrystalline soft magnetic alloy material to a depth of 100 nm, and the central region is located deeper inside of the surface region.

18. The nanocrystalline soft magnetic alloy material according to claim 2, wherein
a relative ratio between a maximum content of a Cu element in a surface region and a maximum content of the Cu element in an inner region is within a range of from 1 to 2.5, where the surface region extends from the surface of the nanocrystalline soft magnetic alloy material to a depth of 20 nm, and the inner region extends from the depth of 20 nm (but not including 20 nm) to a depth of 40 nm and is located deeper inside of the surface region.

19. The nanocrystalline soft magnetic alloy material according to claim 2, wherein
the surface region of the nanocrystalline soft magnetic alloy material contains an average of 30 atom % or more of a Fe element, where the surface region extends from the surface of the nanocrystalline soft magnetic alloy material to the depth of 30 nm.

20. The nanocrystalline soft magnetic alloy material according to claim 2, wherein
the surface of the nanocrystalline soft magnetic alloy material contains iron oxide, silicon oxide, and/or a composite oxide of iron and silicon.
